(19) United States
(12) Patent Application Publication
(10) Pub. No.: US 2009/0073592 A1
(43) Pub. Date: Mar. 19, 2009

(54) COLOR WHEEL

(75) Inventor: KAI HUANG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/964,778

(22) Filed: Dec. 27, 2007

(30) Foreign Application Priority Data
Sep. 14, 2007 (CN) 200710201712.X

(51) Int. Cl. G02B 7/00

(52) U.S. Cl. 359/892; 359/889

(57) ABSTRACT

A color wheel includes a motor defining a rotating portion, a color filter, a sensor and a processor electrically connected to the sensor. The rotating portion defines a groove at the periphery of the rotating portion to aid the sensor in detecting a color index position of the color filter during transmission of light beams to the rotating portion from the sensor. When portions of light beams are striken the groove of the rotating portion, they are substantially absorbed by the groove and cannot be reflected back to the sensor, thereby the sensor can accurately detect the color index position of the color filter during the rotation of the color filter.

### TECHNICAL FIELD

The present invention relates to the art of a color wheel and, particularly, to a color wheel in a projection display device.

### BACKGROUND

Referring to FIG. 1, a related color wheel 100 used in a digital light processing (DLP) projector (not shown) to separate light beams into three colors is provided. The color wheel 100 includes a rotating portion 20 of a motor (not shown), a color filter 10, a timing mark 40 adhered at periphery of the rotating portion 20, a sensor 30 and a processor 25 electrically connected to the sensor 30.

The color filter 10 comprises a red filter segment 12, a blue filter segment 14 and a green filter segment 16. In general, the color filter 10 is mounted on the rotating portion 20 and rotated together with the rotating portion 20. The timing mark 40 is configured to aid the sensor 30 to detect a color index position of the color filter 10 during rotation. When portions of light beams 17 from the sensor 30 are projected onto the timing mark 40 of the rotating portion 20, they are absorbed by the timing mark 40, thereby the sensor 30 can detect the color index position of the color filter 10 because of not receiving a return reflection during the moments the timing mark 40 rotates through the fixed view of the sensor 30. The sensor 30 transmits the color index position to the processor 25 to drive a digital micromirror device (DMD). Clearly, successful operation of the DLP projector depends on properly synchronizing the red, blue, and green image data to the position of the timing mark 40 mounted on the color filter 10.

However, even though the conventional timing mark 40 is generally made from a black or dark light absorbent medium with low reflectivity, when the light beams 17 strike the timing mark 40, some portion of the light beams 17 can still be reflected back to the sensor 30. Thus, the sensitivity of the sensor 30 is impacted, thereby synchronization between the processor 25 and the red, blue, and green image data of the color filter 10 is impacted as well.

What is needed, therefore, is a color wheel with reliable synchronization configuration.

### SUMMARY

In accordance with a present embodiment, a color wheel includes a motor defining a rotating portion, a color filter, a sensor and a processor electrically connected to the sensor. The rotating portion defines a groove at the periphery of the rotating portion to aid the sensor in detecting a color index position of the color filter during transmission of light beams to the rotating portion from the sensor. When portions of light beams are striken the groove of the rotating portion, they are substantially absorbed by the groove and cannot be reflected back to the sensor, thereby the sensor can accurately detect the color index position of the color filter during the rotation of the color filter.

Other advantages and novel features will be drawn from the following detailed description of at least one preferred embodiment, when considered in conjunction with the attached drawings.

### BRIEF DESCRIPTION OF THE DRAWINGS

Many aspects of the present color wheel can be better understood with reference to the following drawings. The components in the drawings are not necessarily drawn to scale, the emphasis instead being placed upon clearly illustrating the principles of the color wheel. Moreover, in the drawings, like reference numerals designate corresponding parts throughout the several views.

FIG. 1 is a perspective view of a related color wheel.

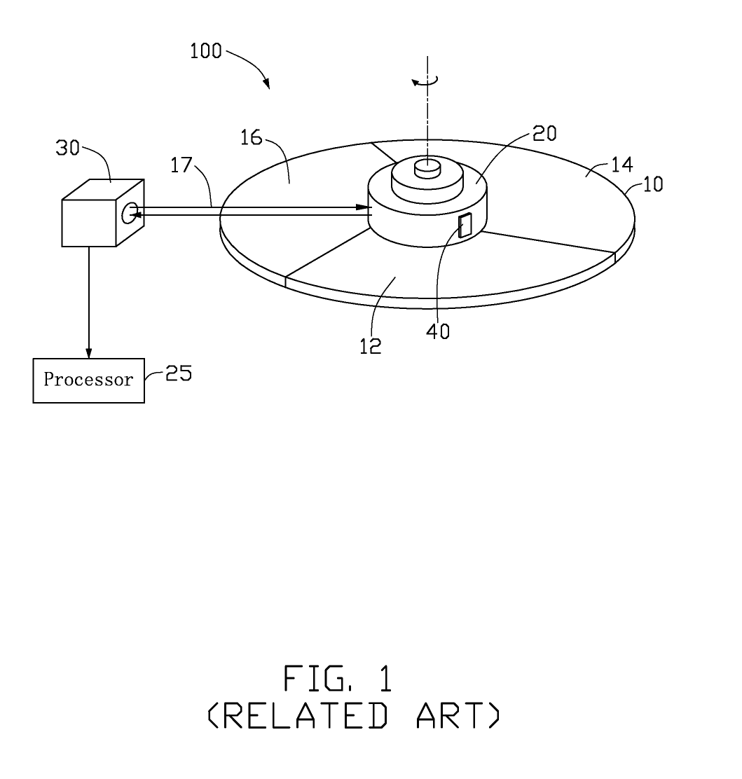

FIG. 2 is a perspective view of a color wheel in accordance with a preferred embodiment of the invention.

### DESCRIPTION OF EMBODIMENT

Embodiments of the present color wheel will now be described in detail below with reference to the drawings.

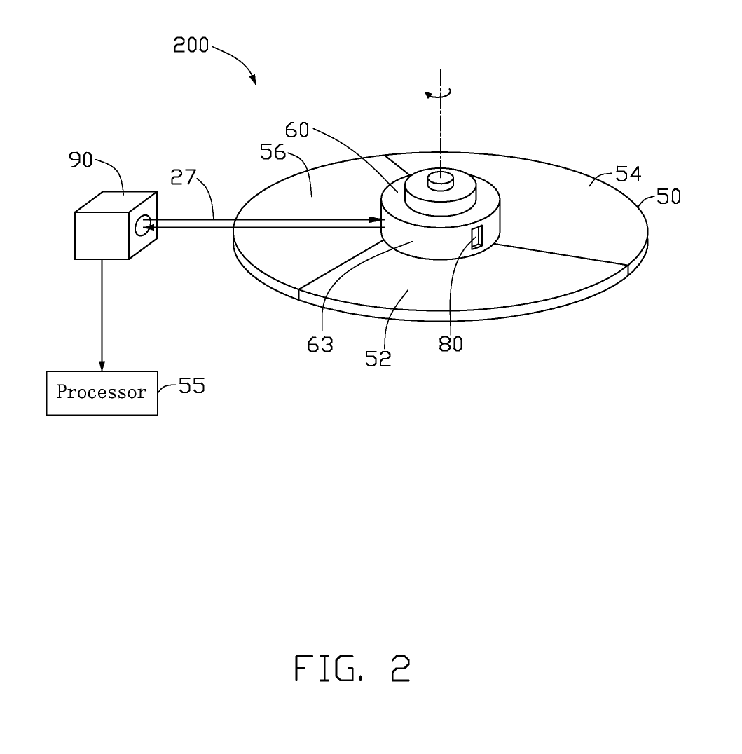

Referring to FIG. 2, a color wheel 200, in accordance with a preferred embodiment, includes a color filter 50, a motor (not shown) with a rotating portion 60, a processor 55 and a sensor 90. The sensor 90 is electrically connected to the processor 55.

The color filter 50 has a transparent plate-configuration, beneficially, made from glass or quartz. The color filter includes a plurality of filter sectors, such as a red filter segment 52, a green filter segment 54 and a blue filter segment 56. The contacting borders of the filter sectors are adhered to each other by a glue and cooperatively form a through hole (not shown) at the center thereof to facilitate mounting of the color filter 50 on the rotating portion 60, thereby the color filter 50 can rotate together with the rotating portion 60.

The rotating portion 60 has a rotating disk 63 aligned with the center axis of the color filter 50. The rotating disk 63 defines a groove 80 at the periphery thereof, for aiding the sensor 90 to detect a color index position of the color filter 50 as it rotates during transmission of light beams 27 to the rotating portion 60 from the sensor 90. When assembling the color filter 50 and the rotating portion 60, a portion of the rotating portion 60 is adhered to areas around the through hole of the color filter 50, thereby reliable engagement between the color filter 50 and the rotating portion 60 is obtained.

The sensor 90 is positioned on a same plane as the groove 80 of the rotating disk 63 thereby receiving reflections of light beams 27 transmitted to the rotating portion 60 from the sensor 90 except during those moments the groove 80 absorbs them. A diameter of light beam 27 is less than that of the groove 80 of the rotating portion 60. The processor 55 is electrically connected to the sensor 90, and can process data from the sensor 90 regarding the color index position of the color filter 50.

When portions of the light beam 27 are exactly projected onto the groove 80 of the rotating portion 60, they are substantially absorbed by the groove 80 and cannot be reflected back to the sensor 90, thereby the sensor 90 can accurately detect the color index position of the color filter 50 accordingly and transmit that information to the processor 55. The processor 55 controls the timing of the color filter 50 rotation to synchronize with light containing image data transmitted through the color filter 50. Thus, both a substantial synchronization and an accurate synthesization of the color are obtained. Additionally, because the groove 80 is formed at the periphery of the rotating portion 60, this configuration not only can substantially absorb the light beams 27, but also can reduce the manufacturing cost of the color wheel and emit heat of the rotating portion 60 during rotation at high speeds.

Although the present invention has been described with reference to particular embodiment, it is not to be construed as being limited thereto. Various alterations and modifications can be made to the embodiments without in any way departing from the scope or spirit of the present invention as defined in the appended claims.

What is claimed is:

1. A color wheel comprising:
a rotating portion having a rotating disk, the rotating disk defining a groove at periphery thereof;
a color filter defining a plurality of filter sectors, the filter sectors adhered to each other and mounted on the rotating portion to rotate together with the rotating portion;
a sensor positioned on a same plane as the groove of the rotating disk;
a processor electrically connected to the sensor; wherein
when portions of light beams are exactly projected into the groove of the rotating portion, said portions of light beams are substantially absorbed by the groove and not reflected back to the sensor, thereby the sensor can accurately detect a color index position of the color filter as the color filter rotates, and transmit that information to the processor so that the processor can control the timing of the color filter rotation to synchronize with light containing image data transmitted through the color filter.

2. The color wheel as claimed in claim 1, wherein the color filter includes a red filter segment, a green filter segment, and a blue filter segment.

3. The color wheel as claimed in claim 2, wherein the diameter of the light beam is less than that of the groove of the rotating portion.

4. The color wheel as claimed in claim 3, wherein the color filter has a transparent plate-configuration and is made from one of glass and quartz.

5. A color wheel comprising:
a rotating disk having a first surface, an opposite second surface and a circumferential reflective side surface extending between the first surface and the second surface, a non-reflective portion being arranged on the reflective side surface;
a color filter mounted on the first surface of the rotating disk for jointly rotating with rotating disk, the color filter including a sector-shaped red filter segment, a sector-shaped green filter segment, and a sector-shaped blue filter segment;
a sensor facing toward the reflective side surface of the rotating disk, the sensor being configured for emitting light beams toward the reflective side surface of the rotating disk and detecting light beams reflected from the reflective side surface of the rotating disk; and
a processor electronically coupled to the sensor, the processor being configured for determining an instant position of the color filter, when rotated with the rotating disk, based on a position of the non-reflective portion relative to the sensor and spatial relationship between the non-reflective portion and the color filter.

6. The color wheel as claimed in claim 5, wherein the rotating disk includes a groove defined in the non-reflective portion thereof.
